(19) United States
(12) Patent Application Publication
(10) Pub. No.: US 2017/0368562 A1
(43) Pub. Date: Dec. 28, 2017

(54) FLUID SEEDERS

(71) Applicant: Delavan Inc, West Des Moines, IA (US)

(72) Inventor: John E. Short, Norwalk, IA (US)

(21) Appl. No.: 15/191,110

(22) Filed: Jun. 23, 2016

(51) Int. Cl. B05B 7/10; F23R 3/28

(52) U.S. Cl. CPC B05B 7/10; F23R 3/286

(57) ABSTRACT

A seeder includes a housing defining a cavity, a housing gas inlet, and a seeder outlet. A sprayer is disposed within the cavity and includes a sprayer gas inlet configured to receive a gas, wherein the sprayer gas inlet is in fluid communication with the housing gas inlet. The sprayer also includes a sprayer liquid intake configured to be in fluid communication with the cavity to intake a liquid media from the cavity and a sprayer nozzle configured to be in fluid communication with the cavity above a liquid level. The sprayer is configured to combine the liquid media with the gas to spray a gas-liquid mixture through the sprayer nozzle and on to an interior spray surface of the housing.

### BACKGROUND

### 1. Field

The present disclosure relates to fluid seeders for seeding particulates into a fluid flow (e.g., for flow testing and/or fuel injectors).

### 2. Description of Related Art

Many systems utilize seeders for dispersing fine particulate (e.g., an oil or fuel into air). Certain systems can utilize Particle Image Velocimetry (PIV) measurements to analyze fluid flow. PIV obtains velocity data by tracking the movement of seed particles in a flow field. For such PIV applications, the particles must be small, uniformly sized, and light enough to be thoroughly distributed. While ambient pressure seeders are readily available, seeders configured for high pressure/high speed applications are not.

Such conventional methods and systems have generally been considered satisfactory for their intended purpose. However, there is still a need in the art for improved fluid seeders, particularly those suited to operate at pressures exceeding 250 psi, for example. Many fluid flow applications exist in which the flow field is contained in a high pressure environment, as for example, in a gas turbine engine. Since flow behaviors differ under these conditions, the ability to make PIV measurements in high pressure environments is needed. The present disclosure provides a solution for this need.

### SUMMARY

In accordance with at least one aspect of this disclosure, a seeder includes a housing defining a cavity, a housing gas inlet, and a seeder outlet. A sprayer is disposed within the cavity and includes a sprayer gas inlet configured to receive a gas, wherein the sprayer gas inlet is in fluid communication with the housing gas inlet. The sprayer also includes a sprayer liquid intake configured to be in fluid communication with the cavity to intake a liquid media from the cavity and a sprayer nozzle configured to be in fluid communication with the cavity above a liquid level.

The sprayer is configured to combine the liquid media with the gas to spray a gas-liquid mixture through the sprayer nozzle and on to an interior spray surface of the housing. The seeder is configured to eject the aerosolized portion of the liquid media through the seeder outlet and to cause a liquid portion of the gas-liquid mixture that is sprayed on the interior spray surface to drip from the interior spray surface without dripping onto the sprayer nozzle.

The seeder can include a mount that mounts the seeder in a vertical position relative to gravity such that the sprayer sprays vertically upward. In certain embodiments, the housing can include a removable cap which defines the interior spray surface.

The interior spray surface can include a conical protrusion that guides the liquid portion to drip downward without dripping into the sprayer nozzle. Any other suitable shape for the interior spray surface is contemplated herein.

In certain embodiments, the sprayer can include a fuel swirler. The sprayer liquid intake can be configured to be below the liquid level. The sprayer liquid intake can include an elbow extension configured to be in fluid communication with a lower portion of the cavity.

The housing can include a view port for viewing a level of the liquid media within the cavity. In certain embodiments, the housing can be configured to withstand pressures over 250 psi.

In accordance with at least one aspect of this disclosure, a method for seeding an airflow with liquid particles can include aspirating liquid stored within a housing with gas flowing through a nozzle, rotationally swirling the gas-liquid mixture, spraying the gas-liquid mixture against an internal surface of the housing, aerosolizing some of the liquid in the gas-liquid mixture, and exhausting the aerosolized liquid from the housing. Exhausting can be done in response to a greater pressure within the housing than outside of the housing, for example.

The method can further include storing liquid within the housing. In certain embodiments, the method can further include returning non-aerosolized liquid to the stored liquid. The method can further include monitoring the liquid stored within the housing. In certain embodiments, the method can further include spraying the gas-liquid mixture above a level of the liquid stored in the housing. The method can further include spraying the gas-liquid mixture vertically.

In accordance with at least one aspect of this disclosure, a seeder can include a housing defining a cavity and having at least one opening, and a nozzle positioned within the cavity having an outlet, a gas inlet and a liquid inlet, the liquid inlet being positioned within the cavity, the nozzle being configured to draw liquid into the nozzle via the liquid inlet in response to gas flowing through the nozzle and to rotationally swirl the gas-liquid mixture and discharge the gas-liquid mixture into the cavity, the at least one opening being configured to exhaust aerosolized liquid from the housing. The nozzle can be a fuel swirler, for example.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a perspective view of an embodiment of a seeder in accordance with this disclosure;

FIG. 2 is a cross-sectional view of the embodiment of FIG. 1, showing an embodiment of a sprayer therein;

FIG. 3 is a cross-sectional view of the embodiment of FIG. 2, showing an embodiment of the sprayer in cross-section; and

FIG. 4 is a partial cross-sectional view of the embodiment of FIG. 2, showing a liquid media disposed within a cavity of the housing of the seeder and the seeder in use.

### DETAILED DESCRIPTION

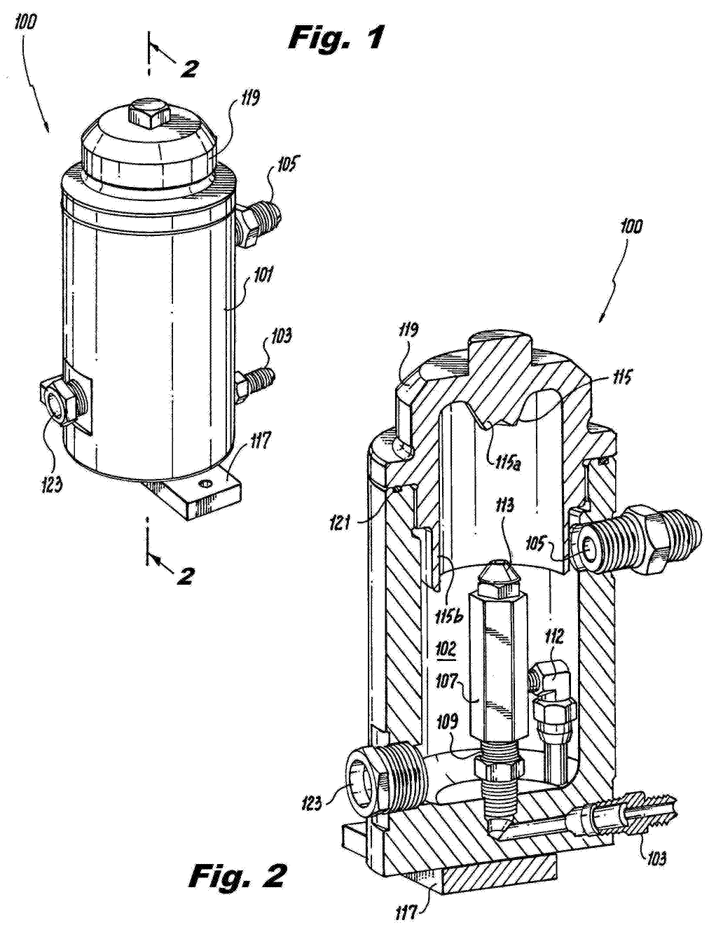

Reference will now be made to the drawings wherein like reference numerals identify similar structural features or aspects of the subject disclosure. For purposes of explanation and illustration, and not limitation, an illustrative view of an embodiment of a seeder in accordance with the disclosure is shown in FIG. 1 and is designated generally by reference character 100. Other embodiments and/or aspects of this disclosure are shown in FIGS. 2-4. The systems and methods described herein can be used to seed a fluid flow (e.g., an airflow) with a particulate.

Referring to FIGS. 1 and 2, a seeder 100 includes a housing 101 defining a cavity 102. The housing 101 also includes a housing gas inlet 103 and a seeder outlet 105. The housing gas inlet 103 and/or the seeder outlet 105 can be defined through the housing 101 and/or include any suitable fitting (e.g., threaded fittings as shown) associated therewith. The seeder outlet 105 can be in fluid communication with a high pressure chamber, in near proximity, via a suitable pipe or hose.

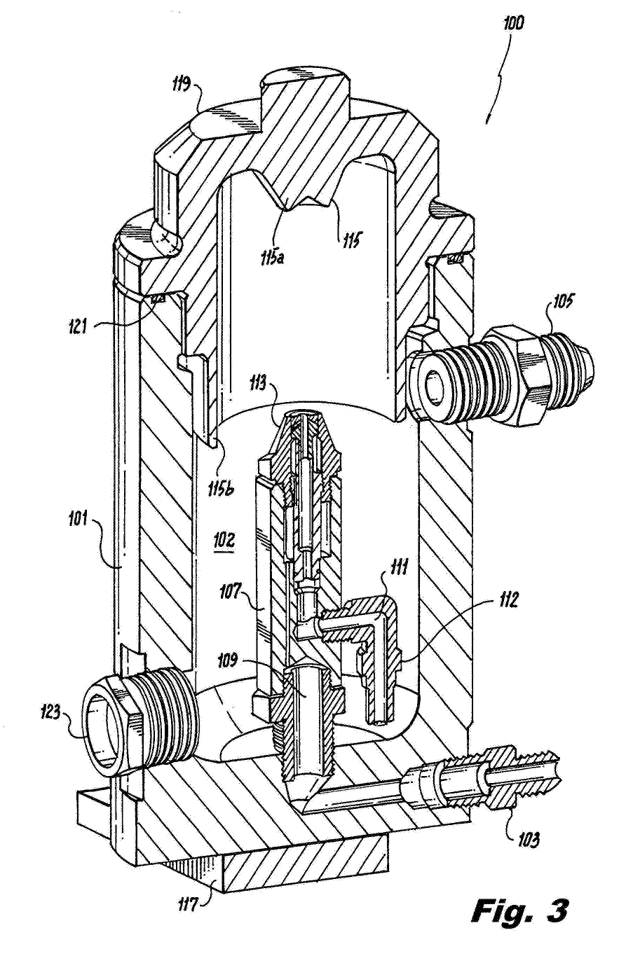

A sprayer 107 is disposed within the cavity 102 and includes a sprayer gas inlet 109 configured to receive a gas (e.g., from a pressurized source of air or nitrogen). Referring additionally to FIG. 3, the sprayer gas inlet 109 can be defined in the sprayer 107 and/or include any suitable fitting (e.g., a threaded fitting) therein. The sprayer gas inlet 109 is in fluid communication with the housing gas inlet 103.

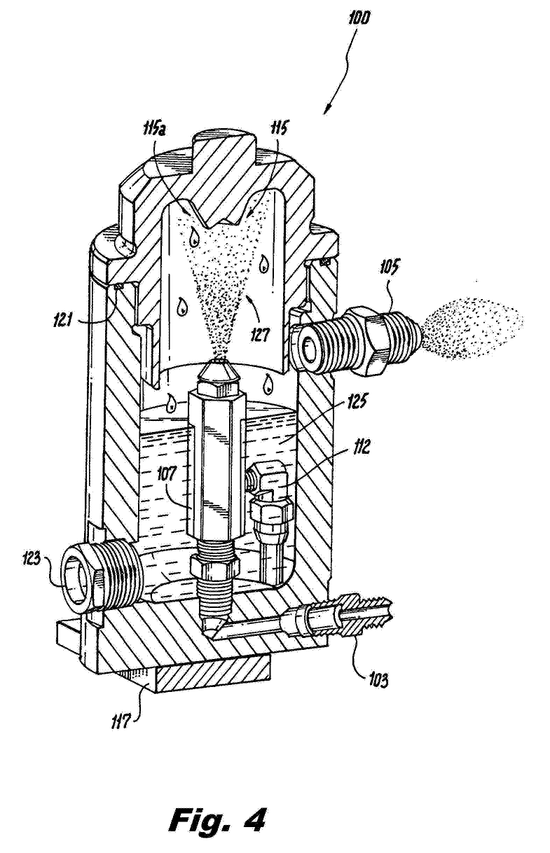

As shown in FIG. 3, the sprayer 107 also includes a sprayer liquid intake 111 configured to be in fluid communication with the cavity 102 to intake a liquid media (e.g., oil) from the cavity 102. The sprayer liquid intake 111 can be configured to be below the liquid level of the liquid media within the cavity (e.g., as shown in FIG. 4), or be in any other suitable location. In certain embodiments, the sprayer liquid intake 111 can further include an elbow extension 112 configured to be in fluid communication with a lower portion of the cavity 102 to allow the sprayer to pull liquid media from the bottom of the cavity.

The sprayer 107 also includes a sprayer nozzle 113 that is in fluid communication with the cavity 102 above the liquid level. In certain embodiments, the sprayer 107 can include a swirler (e.g., a fuel swirler or injector used for turbomachine fuel injectors such as a Delavan® siphon injector part number 30610-1 mounted in a Delavan® adapter part number 29713-2). When pressurized gas is applied to the housing gas inlet 103, the sprayer 107 combines the liquid media with the gas by pulling the liquid media through the sprayer liquid intake 111 and into the gas path (due to the Bernoulli effect) to spray a gas-liquid mixture through the sprayer nozzle 113 and on to an interior spray surface 115 of the housing 101. The closer the sprayer 107 is positioned to the liquid level, relative to a direction of gravity, the lower the pressure differential required to pull the liquid into the liquid intake 111.

As shown in FIG. 4, spraying the gas-liquid mixture 127 aerosolizes a portion of the liquid media 125 into the cavity 102 while causing the non-aerosolized liquid media to impinge on the interior spray surface 115 and eventually drip back into the liquid media in the cavity 102. The seeder 100 ejects the aerosolized portion of the liquid media (due to pressure from the gas) through the seeder outlet 105.

In certain embodiments, the interior spray surface 115 is shaped such that a liquid portion of the gas-liquid mixture that is sprayed on the interior spray surface 115 drip from the interior spray surface 115 without dripping onto the sprayer nozzle 113. For example, the interior spray surface 115 can include a conical protrusion 115a that guides the liquid portion to drip downward without dripping into the sprayer nozzle 113 (e.g., the droplets that form at the center migrate outward from the center of the conical protrusion 115a and drip to the side of the sprayer nozzle 113). The interior spray surface 115 can also include a baffle portion 115b which prevents larger drops from entering the seeder outlet 105 (e.g., by covering the seeder outlet 105 from liquid without blocking a gas path to the seeder outlet 105). The baffle ensures that all but the airborne particles return to the reservoir. Perhaps we should mention this feature. Any other suitable shape for the interior spray surface 115 is contemplated herein.

In certain embodiments, the seeder 100 is be configured to operate substantially vertically relative to a direction of gravity. Accordingly, the seeder 100 can include a mount 117 that mounts the seeder 100 in a vertical position relative to gravity such that the sprayer 107 sprays vertically upward as shown.

In certain embodiments, the housing 101 includes a removable cap 119 which defines the interior spray surface 115. The removable cap 119 can be sealed to the housing 101 (e.g., with one or more seals 121).

In certain embodiments, the housing 101 can include a view port 123 for viewing a level of the liquid media within the cavity 102. The view port 123 can be defined in the housing 101 and/or can be a fitting (e.g., a threaded component as shown). The housing 101 and/or any associated seals, components, and fittings can be sized or otherwise configured for high pressure applications (e.g., to withstand pressures over 250 psi and to maintain any suitable seals to force aerosolized spray out of the seeder outlet 105).

In accordance with at least one aspect of this disclosure, a method for seeding an airflow with liquid particles can include aspirating liquid stored within a housing with gas flowing through a nozzle, rotationally swirling the gas-liquid mixture, spraying the gas-liquid mixture against an internal surface of the housing, aerosolizing some of the liquid in the gas-liquid mixture, and exhausting the aerosolized liquid from the housing. Exhausting can be done in response to a greater pressure within the housing than outside of the housing, for example.

The method can further include storing liquid within the housing. In certain embodiments, the method can further include returning non-aerosolized liquid to the stored liquid. The method can further include monitoring the liquid stored within the housing. In certain embodiments, the method can further include spraying the gas-liquid mixture above a level of the liquid stored in the housing. The method can further include spraying the gas-liquid mixture vertically.

Embodiments as described above allow for seeding at far higher discharge pressures than traditional seeders. The above disclosed embodiments do not require a pump to operate, only pressurized gas such as air or nitrogen (e.g., at a pressure above the pressure at the injection site). Any suitable liquid media (e.g., olive oil or other low viscosity fluids) can be used.

Certain embodiments can be used in fluid flow analysis in a high pressure/high speed environment. Also, certain embodiments can be used in fuel cell reformers. For example, low kW reformer systems require small amounts of fuel, but also fine atomization and uniform mixing with air and steam, prior to entering a catalyst bed. It has been a challenge since passage sizes become very small and fuel pressure is reduced to the point that the operating range is limited. Embodiments can overcome such challenges with aerosol output with low cost, robustness, and minimal parasitic power demand.

The methods and systems of the present disclosure, as described above and shown in the drawings, provide for seeders with superior properties. While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. A seeder, comprising:
a housing defining a cavity and including a housing gas inlet and a seeder outlet;
a sprayer disposed within the cavity, including:
a sprayer gas inlet configured to receive a gas, the sprayer gas inlet in fluid communication with the housing gas inlet;
a sprayer liquid intake configured to be in fluid communication with the cavity to intake a liquid media from the cavity; and
a sprayer nozzle configured to be in fluid communication with the cavity above a liquid level, wherein the sprayer is configured to combine the liquid media with the gas to spray a gas-liquid mixture through the sprayer nozzle and on to an interior spray surface of the housing,
wherein the seeder is configured to eject the aerosolized portion of the liquid media through the seeder outlet and to cause a liquid portion of the gas-liquid mixture that is sprayed on the interior spray surface to drip from the interior spray surface without dripping onto the sprayer nozzle.

2. The seeder of claim 1, wherein the seeder includes a mount that mounts the seeder in a vertical position relative to gravity such that the sprayer sprays vertically upward.

3. The seeder of claim 1, wherein the housing further includes a removable cap which defines the interior spray surface.

4. The seeder of claim 2, wherein the interior spray surface includes a conical protrusion that guides the liquid portion to drip downward without dripping into the sprayer nozzle.

5. The seeder of claim 1, wherein the sprayer includes a fuel swirler.

6. The seeder of claim 1, wherein the sprayer liquid intake includes an elbow extension configured to be in fluid communication with a lower portion of the cavity.

7. The seeder of claim 1, wherein the housing further includes a view port for viewing a level of the liquid media within the cavity.

8. The seeder of claim 1, wherein the housing is configured to withstand pressures over 250 psi.

9. The seeder of claim 1, wherein the sprayer liquid intake is configured to be below the liquid level.

10. A method for seeding an airflow with liquid particles, comprising:
aspirating liquid stored within a housing with gas flowing through a nozzle;
rotationally swirling the gas-liquid mixture;
spraying the gas-liquid mixture against an internal surface of the housing;
aerosolizing some of the liquid in the gas-liquid mixture; and
exhausting the aerosolized liquid from the housing.

11. The method of claim 10, further comprising storing liquid within the housing.

12. The method of claim 11, further comprising returning non-aerosolized liquid to the stored liquid.

13. The method of claim 11, further comprising monitoring the liquid stored within the housing.

14. The method of claim 11, further comprising spraying the gas-liquid mixture above a level of the liquid stored in the housing.

15. The method of claim 10, further comprising spraying the gas-liquid mixture vertically.

16. The method of claim 11, wherein the exhausting is in response to a greater pressure within the housing than outside of the housing.

17. A seeder, comprising:
a housing defining a cavity and having at least one opening; and
a nozzle positioned within the cavity having an outlet, a gas inlet and a liquid inlet, the liquid inlet being positioned within the cavity, the nozzle being configured to draw liquid into the nozzle via the liquid inlet in response to gas flowing through the nozzle and to rotationally swirl the gas-liquid mixture and discharge the gas-liquid mixture into the cavity, the at least one opening being configured to exhaust aerosolized liquid from the housing.

18. The seeder of claim 17, wherein the nozzle is a fuel swirler.
